(19) United States
(12) Patent Application Publication
(10) Pub. No.: US 2012/0005321 A1
(43) Pub. Date: Jan. 5, 2012

(54) ROUTER AND REMOTE BOOT METHOD USING THE ROUTER

(75) Inventors: MING-XIANG HU, Shenzhen City (CN); LE LIN, Shenzhen City (CN); JUN-MIN CHEN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/037,117

(22) Filed: Feb. 28, 2011

(30) Foreign Application Priority Data
Jun. 30, 2010 (CN) 201010213745.8

(51) Int. Cl. G06F 15/177; H04L 12/56

(52) U.S. Cl. 709/222; 709/220; 370/390

(57) ABSTRACT

A router providing remote boot for computers includes a DHCP/proxy DHCP service module to send an IP address to a computer, in response to a DHCP Discover packet sent from the computer, a boot service module to send a DHCPACK packet, which includes a filename of a remote boot mirror image and configuration parameters of TFTP/MTFTP, to the computer in response to a BSDP packet sent from the computer, and a MTFTP/TFTP service module to establish a connection between the router and computer enabling the computer to download the remote boot mirror image according to the configuration parameters of TFTP/MTFTP, in response to a request packet sent from the computer.

### BACKGROUND

1. Technical Field

Embodiments of the present disclosure generally relate to routers, and more particularly to a router and a remote boot method that remotely boots computers using the router.

2. Description of Related Art

Many computers with built-in network cards provide support for remote network booting using Preboot eXecution Environment (PXE). The PXE (also known as Pre-Execution Environment) is an environment that allows for booting of the computers using a network interface independent of data storage devices (like hard disks) or installed operating systems.

In use, it is necessary to set up a PXE-server which allows the computers to request an IP address via Dynamic Host Configuration Protocol (DHCP), and download a kernel via Trivial File Transfer Protocol (TFTP). In addition, in order to avoid conflicts with original networks, an extra network must be set up between the computers and the PXE-server for communications, a troublesome and costly requirement.

### BRIEF DESCRIPTION OF THE DRAWINGS

FIG. 1 is a block diagram illustrating a router, according to embodiments of the present disclosure.

FIGS. 2 and 3 are flowcharts respectively illustrating a remote boot method performed by a router, such as, that of FIG. 1, according to embodiments of the present disclosure.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may be comprised of connected logic units, such as gates and flip-flops, and may be comprised of programmable units, such as programmable gate arrays or processors. The modules described herein may be implemented as either software and/or hardware modules and may be stored in any type of computer-readable medium or other computer storage device.

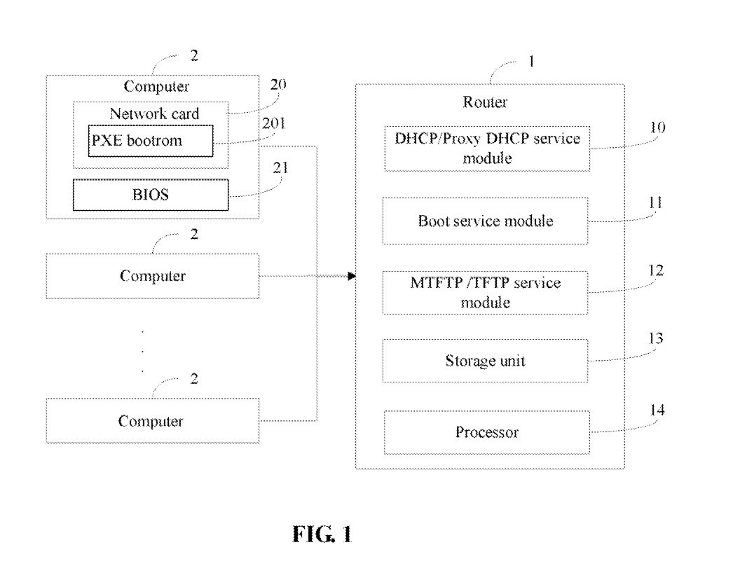

FIG. 1 is a block diagram illustrating a router 1, according to embodiments of the present disclosure. The router 1 includes a DHCP/proxy DHCP service module 10, a boot service module 11, a Multicast Trivial File Transfer Protocol (MTFTP)/TFTP service module 12, a storage unit 13, and a processor 14. These components 1014 communicate over one or more communication buses or signal lines (not shown). It should be appreciated that the router 1 may have more or fewer components than shown in FIG. 1, or a different configuration of components. The various components shown in FIG. 1 may be implemented in hardware, software or a combination thereof, including one or more signal processing and/or application specific integrated circuit.

The router 1 communicates with one or more computers 2 (three shown) via Internet or intranet (not shown). Each computer 2 includes a network card 20 which has the PXE, and a basic input/output system (BIOS) 21. The network card 20 includes a PXE bootrom to realize the PXE. In one embodiment, the PXE bootrom automatically runs when the computer 2 is turned on. The BIOS 21 initializes the network card 20 and the computer 2 when the computer 2 is turned on.

The DHCP/proxy DHCP service module 10, the boot service module 11, and the MTFTP/TFTP service module 12 may include one or more computerized codes in the form of one or more programs that are stored in the storage unit 13. The storage unit 13 may include high speed random access memory and may also include non-volatile memory, such as one or more magnetic disk storage devices, flash memory devices, or other non-volatile solid state memory devices. The one or more computerized codes of the modules 1012 include instructions executed by the processor 14, to provide functions for the modules of the module 10˜12.

DHCP/proxy DHCP service module 10 is operable to allocate an internet protocol (IP) address to the computer 2 in response to a DHCP Discover packet sent from the computer 2. It may be appreciated that, when the computer 2 is in the initialization state, the computer 2 has no IP address. To obtain an IP address, the computer 2 creates the DHCP Discover packet, which includes a hardware address of the computer 2 and a random transaction identifier. After receiving the DHCP Discover packet, the DHCP/proxy DHCP service module 10 of the router 1 creates a DHCP offer packet, which includes the IP address allocated to the computer 2, a lease of the IP address, and the same transaction identifier used in the DHCP Discover packet.

The boot service module 11 is operable to send a DHCPACK packet, which includes a filename of a remote boot mirror image and configuration parameters of TFTP/MTFTP, to the computer 2 in response to a Boot service Discover protocol (BSDP) packet sent from the computer 2. The BSDP packet requires the router 1 to provide resources that enable the computer 2 to boot a suitable operating system.

The MTFTP/TFTP service module 12 is operable to establish a connection between the router 1 and computer 2 enabling the computer 2 to download the remote boot mirror image according to the configuration parameters of TFTP/MTFTP, in response to a request packet sent from the computer 2. It may be appreciated that the request packet includes a request to download the remote boot mirror image.

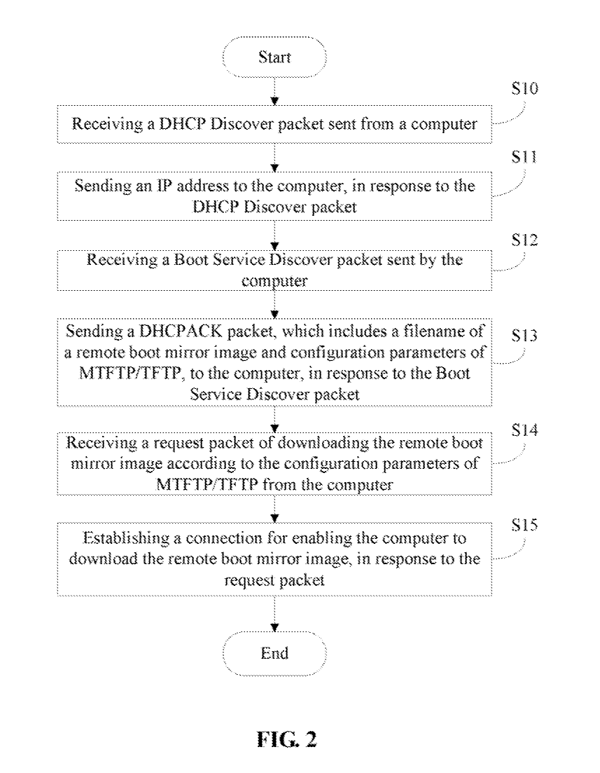

FIG. 2 is a flowchart illustrating a remote boot method performed by a router, such as, the router 1, according to embodiments of the present disclosure, implemented by execution of computer readable program code by the processor 14 of the router 1. Depending on the embodiment, additional blocks in the flow of FIG. 2 may be added, others removed, and the ordering of the blocks may be changed.

In block S10, DHCP/proxy DHCP service module 10 receives a DHCP Discover packet sent from the computer 2. In one embodiment, the DHCP Discover packet includes information of a hardware address of the computer 2 and a random transaction identifier.

In block S11, the DHCP/proxy DHCP service module 10 sends an Internet protocol (IP) address to the computer 2 in response to the DHCP Discover packet. In one embodiment, the IP address is included in a DHCP offer packet created by the DHCP/proxy DHCP service module 10. The DHCP offer packet may further include a lease of the IP address and the same transaction identifier used in the DHCP Discover packet.

In block S12, the boot service module 11 receives a Boot service Discover protocol (BSDP) packet sent from the computer 2. The BSDP packet requires the router 1 to provide resources that enable the computer 2 to boot a suitable operating system.

In block S13, the boot service module 11 sends a DHCPACK packet, which includes a filename of a remote boot mirror image and configuration parameters of TFTP/MTFTP, to the computer 2 in response to the BSDP packet.

In block S14, The MTFTP/TFTP service module 12 receives a request packet to download the remote boot mirror image according to the configuration parameters of TFTP/MTFTP sent from the computer 2.

In block S15, the MTFTP/TFTP service module 13 establishes a connection between the router 1 and computer 2 enabling the computer 2 to download the remote boot mirror image according to the configuration parameters of TFTP/MTFTP.

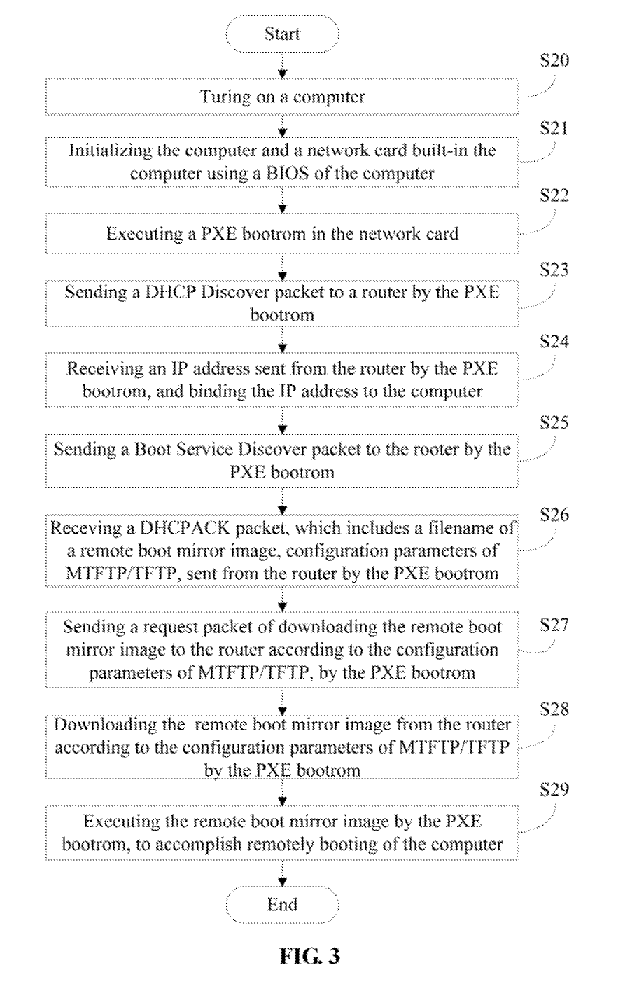

FIG. 3 is also a flowchart illustrating a remote boot method performed by a router, such as, the router. 1, according to embodiments of the present disclosure, implemented by execution of computer readable program code by the processor 14 of the router 1. Depending on the embodiment, additional blocks in the flow of FIG. 3 may be added, others removed, and the ordering of the blocks may be changed.

In block S20, the computer 2 is turned on.

In block S21, the BIOS 21 of the computer 2 initializes the computer 2 and the network card 20 of the computer 2.

In block S22, the PXE bootrom 201 in the network card 20 is automatically executed.

In block S23, the PXE bootrom 201 sends a DHCP Discover packet to the router 1. In one embodiment, the DHCP Discover packet includes information of a hardware address of the computer 2 and a random transaction identifier.

In block S24, the PXE bootrom 201 receives an internet protocol (IP) address sent from the router 1, and binds the IP address to the computer 2. In one embodiment, the IP address is included in a DHCP offer packet created by the router 1. The DHCP offer packet may further include a lease of the IP address and the same transaction identifier used in the DHCP Discover packet.

In block S25, the PXE bootrom 201 sends a Boot service Discover protocol (BSDP) packet to the router 1. The BSDP packet requires the router 1 to provide resources that enable the computer 2 to boot a suitable operating system.

In block S26, the PXE bootrom 201 receives a DHCPACK packet which includes a filename of a remote boot mirror image and configuration parameters of TFTP/MTFTP from the router 1.

In block S27, the PXE bootrom 201 sends a request packet to download the remote boot mirror image according to the configuration parameters of TFTP/MTFTP to the router 1.

In block S28, the PXE bootrom 201 downloads the remote boot mirror image according to the configuration parameters of TFTP/MTFTP based on a connection established by the router 1.

In block S29, the PXE bootrom 201 executes the remote boot mirror image to accomplish remote booting of the computer 2.

Although certain inventive embodiments of the present disclosure have been specifically described, the present disclosure is not to be construed as being limited thereto. Various changes or modifications may be made to the present disclosure beyond departing from the scope and spirit of the present disclosure.

What is claimed is:

1. A router, comprising:
at least one processor;
a storage unit;
one or more programs that are stored in the storage unit and are executed by the at least one processor, the one or more programs comprising:
a Dynamic Host Configuration Protocol (DHCP)/proxy DHCP service module configured to send an Internet Protocol (IP) address to a computer, in response to a DHCP Discover packet sent from the computer;
a boot service module configured to send a DHCPACK packet, which includes a filename of a remote boot mirror image and configuration parameters of TFTP/MTFTP, to the computer in response to a Boot service Discover protocol (BSDP) packet sent from the computer;
a Multicast Trivial File Transfer Protocol (MTFTP)/Trivial File Transfer Protocol (TFTP) service module configured to establish a connection between the router and computer enabling the computer to download the remote boot mirror image according to the configuration parameters of TFTP/MTFTP, in response to a request packet sent from the computer.

2. The router as described in claim 1, wherein the computer comprises:
a network card which has a Preboot eXecution Environment (PXE) bootrom to realize the PXE of the network card.

3. The router as described in claim 2, wherein the computer further comprises:
a basic input/output system (BIOS) to initialize the network card and the computer when the computer is turned on.

4. The router as described in claim 1, wherein the DHCP Discover packet sent from the computer comprises a hardware address of the computer and a random transaction identifier.

5. The router as described in claim 4, wherein the IP address sent by the DHCP/proxy DHCP service module is contained in a DHCP offer packet, which further contains a lease of the IP address and the same transaction identifier used in the DHCP Discover packet.

6. A remote boot method using the router as described in claim 1, comprising:
receiving a Dynamic Host Configuration Protocol (DHCP) Discover packet sent from the computer;
sending an Internet Protocol (IP) address to the computer, in response to receiving the DHCP Discover packet;
receiving a Boot service Discover protocol (BSDP) packet sent from the computer;
sending a DHCPACK packet which includes a filename of a remote boot mirror image and configuration parameters of Multicast Trivial File Transfer Protocol (MTFTP)/Trivial File Transfer Protocol (TFTP) to the computer, in response to the BSDP packet.
receiving a request packet to download the remote boot mirror image according to the configuration parameters of TFTP/MTFTP sent from the computer; and
establishing a connection between the router and computer enabling the computer to download the remote boot mirror image according to the configuration parameters of TFTP/MTFTP.

7. The method as described in claim 6, wherein the computer comprises:
a network card which has a Preboot eXecution Environment (PXE) bootrom to realize the PXE of the network card.

8. The method as described in claim 7, wherein the computer further comprises:
a basic input/output system (BIOS) to initialize the network card and the computer when the computer is turned on.

9. The method as described in claim 6, wherein the DHCP Discover packet sent from the computer comprises a hardware address of the computer and a random transaction identifier.

10. The method as described in claim 6, wherein the IP address is contained in a DHCP offer packet which further contains a lease of the IP address, and the same transaction identifier used in the DHCP Discover packet.

11. A remote boot method using the router as described in claim 1, comprising:
sending a DHCP Discover packet to the router;
receiving an Internet Protocol (IP) address sent from the router, and binding the IP address to the computer;
sending a Boot service Discover protocol (BSDP) packet to the router;
receiving a DHCPACK packet which includes a filename of a remote boot mirror image and configuration parameters of TFTP/MTFTP from the router;
sending a request packet to download the remote boot mirror image according to the configuration parameters of TFTP/MTFTP to the router;
downloading the remote boot mirror image according to the configuration parameters of TFTP/MTFTP based on a connection established by the router; and
executing the remote boot mirror image to accomplish remotely booting of a computer.

12. The method as described in claim 11, before sending a DHCP Discover packet to the router, further comprising:
turning on the computer;
initializing the computer and a network card built-in the computer by a basic input/output system (BIOS) of the computer; and
executing a PXE bootrom in the network card automatically.

13. The method as described in claim 11, wherein the DHCP Discover packet sent from the computer comprises a hardware address of the computer and a random transaction identifier.

14. The method as described in claim 11, wherein the IP address is contained in a DHCP offer packet which further contains a lease of the IP address, and the same transaction identifier used in the DHCP Discover packet.
